(19) United States
(12) Patent Application Publication
(10) Pub. No.: US 2026/0336449 A1
(43) Pub. Date: Oct. 29, 2026

(54) ELECTRIC VEHICLE CHARGING DEVICE AND METHOD USING HOUSEHOLD SOLAR INVERTER

(71) Applicant: HANWHA SOLUTIONS CORPORATION, Seoul (KR)

(72) Inventors: Seung Joo BAEK, Seoul (KR); Seung Hyeok JANG, Seoul (KR)

(73) Assignee: HANWHA SOLUTIONS CORPORATION, Seoul (KR)

(21) Appl. No.: 19/119,551

(22) PCT Filed: Nov. 1, 2023
(86) PCT No.: PCT/KR2023/017279

§ 371 Date: Apr. 9, 2025

(30) Foreign Application Priority Data
Nov. 14, 2022 (KR) 10-2022-0151173

(51) Int. Cl. B60L 53/51; B60L 53/66; B60L 55/00; H02J 7/35; H02J 105/10; H02J 105/37

(52) U.S. Cl. CPC B60L 53/51; B60L 53/66; B60L 55/00; H02J 7/35; H02J 2105/10; H02J 2105/37; H02J 2207/20

(57) ABSTRACT

The present disclosure relates to an electric vehicle charging device and method using a household solar inverter, and includes a first inverter of a household solar power generating equipment, and a first converter for converting the power of a DC link unit connected to the first inverter to charging power and supplying the charging power to the electric vehicle through a charging cable, to charge the electric vehicle, wherein the power of a second converter based on a solar module, the power of a second inverter based on a grid, and the power of a third converter based on a battery are supplied to the DC link unit.

### TECHNICAL FIELD

The present disclosure relates to an electric vehicle charging device and method using a household solar inverter, and more particularly, to a charging device and method of providing charging power in a range between the slow charging and the fast charging using direct current (DC) power generated from a solar module, DC power of a battery, and alternating current (AC) power from a grid.

### BACKGROUND ART

Recently, as the popularity of electric vehicles has increased, it is known that 358,253 electric vehicles were registered as of April 2022, and the number of electric vehicles registered is expected to increase rapidly with the launch of various electric vehicles.

It is known that 2.5 chargers are needed per electric vehicle, and while 3 chargers are provided per electric vehicle in Europe, 0.5 chargers are provided per electric vehicle in Korea, which is a lack of charging infrastructure.

As an alternative to this, technologies for charging electric vehicles using household power have been proposed. However, as the battery for the electric vehicle is gradually increasing in capacity (20 kWh->around 60 kWh), there are disadvantages in that the slow charging by household AC power takes a long time required for charging and is inefficient.

Currently, the method of charging electric vehicles is divided into slow charging that charges for 4 to 5 hours with a charging capacity of 3 to 7 KW and fast charging that charges quickly within 30 minutes with a charging capacity of 50 kW. The fast charging method continuously increases charging capacity (for example, 400 to 700 kW) to shorten the charging time, however, when many vehicles are charged at the same time, the power grid is difficult to operate, so that it is policy-driven to perform the fast charging only during light load times.

Accordingly, there has been suggestions of technology for charging an electric vehicle connected with solar power generation, and patent registration No. 10-1775957 (registered on Sep. 1, 2017, power applying system for connecting photovoltaic power generating apparatus) discloses a system for applying electric power, which is obtained from a solar power generation apparatus, to an electric vehicle in an AC or DC method, to charge the electric vehicle.

The registered patent mentioned above supports AC (slow) and DC (fast) charging, but as described above, both the slow charging and the fast charging have their own problems, so there is a request for developing technical means to solve those problems.

In addition, the registered patent mentioned above discloses a configuration only using a battery for DC fast charging, but as the capacity of electric vehicle batteries increases, there are also limits that it is practically difficult to charge the electric vehicle battery by only using the charging power of the battery.

DISCLOSURE

### Technical Problem

The object that the present disclosure seeks to solve in consideration of the market demands and problems of the prior art as described above is to provide an electric vehicle charging device that may solve the problems of slow charging and fast charging, respectively, and shorten the charging time and alleviate the overload of the power grid.

Particularly, another object that the present disclosure seeks to solve is to provide an electric vehicle charging device for charging the battery of an electric vehicle from the DC link by connecting the DC power generated in a household solar module, the power received from a grid and the power of a battery.

### Technical Solution

In order to solve the technical problems described above, the electric vehicle charging device according to the present disclosure includes a first inverter of a household solar power generating equipment, and a first converter converting power of a direct current (DC) link unit connected to the first inverter to charging power and supplying the charging power to an electric vehicle through a charging cable, to charge the electric vehicle, wherein the power of a second converter based on a solar module, the power of a second inverter based on a grid, and the power of a third converter based on a battery are supplied to the DC link unit.

In an embodiment of the present disclosure, the first converter may further include a communication unit that communicating with the electric vehicle.

In an embodiment of the present disclosure, the second converter may convert the DC power of the solar module to constant DC power of a constant amount and may supply the constant DC power to the DC link unit, and the second inverter may convert alternating current (AC) power of the grid to DC power and supply the converted DC power to the DC link unit, or may convert the DC power of the DC link unit to AC and supply the AC to the grid or a load.

In an embodiment of the present disclosure, the third converter may supply the power of the battery to the DC link unit or may supply the power of the DC link unit to the battery.

In an embodiment of the present disclosure, a DC optimizer installed to the solar module may be further included.

In an embodiment of the present disclosure, the second converter and the second inverter may be included in the first inverter, and the third converter may be provided separately from the first inverter.

In an embodiment of the present disclosure, the first inverter may include the second converter, the second inverter, and the third converter.

In an embodiment of the present disclosure, the first converter may be separable from the first inverter.

The household electric vehicle charging device according to another aspect of the present disclosure may include a first inverter, a first converter converting power of a direct current (DC) link unit to a third charging power between a first charging power and a second charging power and supplying the third charging power to the electric vehicle, wherein the first inverter includes a second converter converting the DC power of a solar module and providing the converted DC power to the DC link unit, and a second inverter converting the alternating current (AC) power of a grid and providing the converted AC power to the DC link unit.

In an embodiment of the present disclosure, a third converter for providing the power of a battery to the DC link unit may be included, and the third converter may be included in the first inverter or may be provided separately from the first inverter and connected to the first inverter.

In an embodiment of the present disclosure, the second inverter may be a bidirectional inverter and provide the power of the DC link unit to the grid and the load, and the third converter may be a bidirectional converter and charge the battery with the power of the DC link unit.

In an embodiment of the present disclosure, the first converter may be a bidirectional converter and provide the power of the electric vehicle to the DC link unit.

In an embodiment of the present disclosure, the first charging power may be greater than or equal to 3 KW and less than or equal to 7 KW, the second charging power may be 50 kW, and the first converter may convert the power of the DC link unit to the third charging power of greater than or equal to 20 KW and less than or equal to 40 KW, to charge the electric vehicle.

In an embodiment of the present disclosure, the first converter includes a communication unit that performs an inter-process communication (PLC) with an electric vehicle communication controller (EVCC) of the electric vehicle.

In an embodiment of the present disclosure, a vehicle to grid (V2G) communication, a vehicle to load (V2L) communication, and a plug and charge (PnC) communication may be possible by the communication unit.

In an embodiment of the present disclosure, a DC optimizer added to the solar module may be further included.

In an embodiment of the present disclosure, the second converter and the second inverter may be provided as the first inverter, and the first converter may be separable from the first inverter.

A method of charging an electric vehicle according to another aspect of the present disclosure may be a method of charging an electric vehicle by converting the power of a DC link unit of a household solar inverter to DC power, wherein the DC link unit links the power of a solar module, the power of a grid, and the power of a battery, and the charging power of the electric vehicle may be converted to a third charging power between a first charging power and a second charging power.

In an embodiment of the present disclosure, the first charging power may be greater than or equal to 3 KW and less than or equal to 7 KW, the second charging power may be 50 kW, and the third charging power for charging the electric vehicle may be greater than or equal to 20 kW and less than or equal to 40 kW.

In an embodiment of the present disclosure, the third converter may be separable.

### Advantageous Effects

The present disclosure provides DC power between the slow charging and the fast charging, so that there is an effect that the problem of long charging time in the slow charging and the problem of increased load of power grid in the fast charging are solved, respectively.

In addition, the present disclosure enables the electric vehicle to be charged by adding a converter and a charger to a household solar power generating equipment, to facilitate the introduction of equipment for charging household electric vehicles with reduced cost.

### DESCRIPTION OF DRAWINGS

FIG. 1 is a block diagram of an electric vehicle charging device according to a preferred embodiment of the present disclosure.

FIGS. 2 to 6 are block diagrams of an electric vehicle charging device according to other embodiments of the present disclosure, respectively.

### BEST MODE

In order to fully understand the configuration and effects of the present disclosure, preferred embodiments of the present disclosure will be described with reference to the attached drawings. However, the present disclosure is not limited to the embodiments disclosed below and may be implemented in various forms and various changes may be applied thereto. However, the description of the present embodiments is provided to make the disclosure of the present disclosure complete and to fully inform those skilled in the art of the invention of the scope of the invention. In the attached drawings, the components are illustrated to be enlarged in size than they are for convenience of explanation, and the ratio of each component may be exaggerated or reduced.

Terms such as ‘first’, ‘second’, etc. may be used to describe various components, but the components should not be limited by those terms. The terms described above may be used only for the purpose of distinguishing one component from another component. For example, without departing from the scope of the present disclosure, the ‘first component’ may be referred to as a ‘second component’, and similarly, the ‘second component’ may also be referred to as a ‘first component’. In addition, singular expressions include plural expressions unless the context is explicitly expressed otherwise. Unless otherwise defined, the terms used in the embodiments of the present disclosure may be interpreted as meanings generally known to those skilled in the art.

Hereinafter, a proportional-integral-differential (PID) control apparatus and method according to an embodiment of the present disclosure will be specifically described with reference to the drawings.

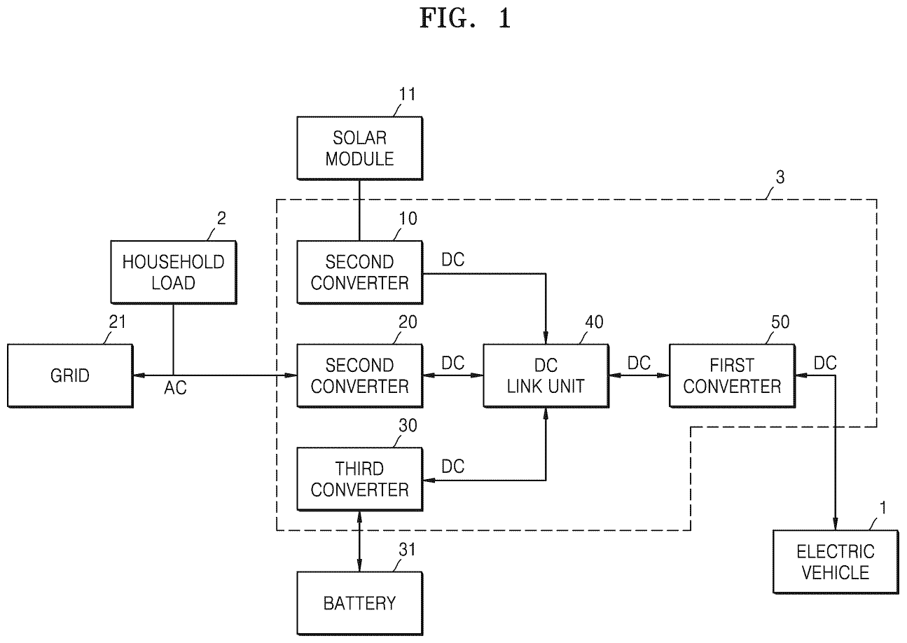

FIG. 1 is a block diagram of an electric vehicle charging device according to a preferred embodiment of the present disclosure.

Referring to FIG. 1, the present disclosure includes a second converter 10 that converts power generated in a solar module 11 to constant DC power, a second inverter 20 that converts AC power of a power grid 21 to DC power, a third converter 30 that converts and outputs power of a battery 31, a DC link unit 40 that links the DC power of the second converter 10, the second inverter 20, and the third converter 30, and a first converter 50 that converts the power of the DC link unit 40 to DC power for charging an electric vehicle 1 and supplies the DC power to the electric vehicle 1 through a charging cable.

In some embodiments, the second converter 10, the second inverter 20, the third converter 30 and the DC link unit 40 are formed into a first inverter 3.

Hereinafter, the configuration and operation of the electric vehicle charging device of the present disclosure configured as described above will be described in more detail.

First, the present disclosure adds the first converter 50 to the first inverter 3 of a conventional household solar power generating equipment for charging an electric vehicle 1 in such a configuration that the output power of the first converter 50 is set between the charging power for the conventional slow charging and the charging power for the fast charging. For example, the first converter 50 may output the charging power of 20 to 40 kW.

The DC power obtained in the solar module 11 may be converted to the constant DC power in the second converter 10, and the second converter 10 may use a boost or buck-boost converter.

The power of the grid 21 that supplies household power (single-phase 220 V, 240 V, etc.) is converted to DC power by the second inverter 20 that is a bidirectional AC/DC converter.

A grid connected inverter may be configured by the second inverter 20. That is, the DC power of the second converter 10 may be converted to AC power using the second inverter 20 and the AC power is supplied to the grid 21 or the household load 2.

The third converter 30 is a bidirectional DC/DC converter and serves to charge the battery 31 using the DC power of the second converter 10 or the second inverter 20, or to perform a process of converting the output power of the battery 31 to the AC in the second inverter 20.

In some embodiments, the outputs of the second converter 10, the second inverter 20, and the third converter 30 are linked by the DC link unit 40. The DC link unit 40 may include a DC link capacitor having appropriate capacity.

The second converter 10, the second inverter 20, the third converter 30 and the DC link unit 40 may form the first inverter 3 that is an inverter of the household solar power generating equipment.

The first converter 50 may be a bidirectional DC/DC converter connected to the DC link unit 40.

The first converter 50 may charge the electric vehicle 1 by supplying the DC power of the DC link unit 40 to the electric vehicle 1 through a charging cable. This charging is performed using DC power to directly charge the battery of the electric vehicle 1 by bypassing the power conversion device (OBC) of the electric vehicle 1.

In this way, according to the present disclosure, an electric vehicle may be charged by a simple configuration of adding the first converter 50 to the first inverter 3 of the household solar power generating equipment and the problems of the slow charging and the fast charging may be solved, respectively, by supplying the DC power between the slow charging and the fast charging.

In addition, compared to the conventional charging system only using the power of the battery 31, the charging reliability may increase, and the charging stability may be secured.

As the first converter 50 is configured as the bidirectional converter, the battery power of the electric vehicle 1 may be supplied to the household load 2 and the grid 21 if necessary. In such a case, the battery power of the electric vehicle 1 is converted in the first converter 50 and the converted power is supplied to the DC link unit 40 and is converted to the AC power by the second inverter 20.

In addition, the first converter 50 may be an insulated converter.

As described above, the present disclosure may provide bidirectional power conversion, thereby enabling various applications.

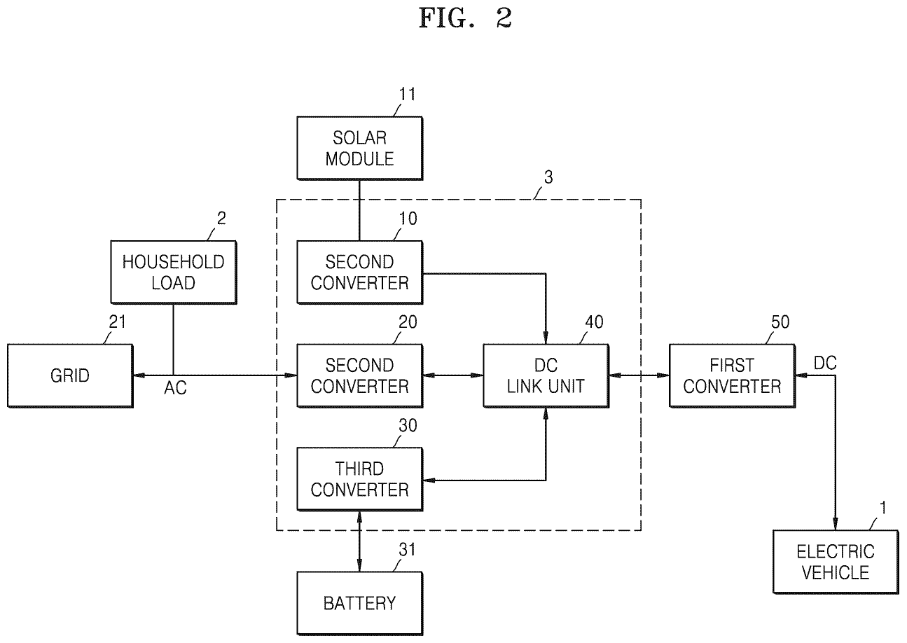

FIG. 2 is a block diagram in which an electric vehicle charging unit is separated according to another embodiment of the present disclosure.

Referring to FIG. 2, when a solar module 11, a second converter 10, a second inverter 20, a battery 31, and a third converter 30 are installed, the first converter 50 is separated in a structure and may be used for charging an electric vehicle as described above in the example embodiment of FIG. 1.

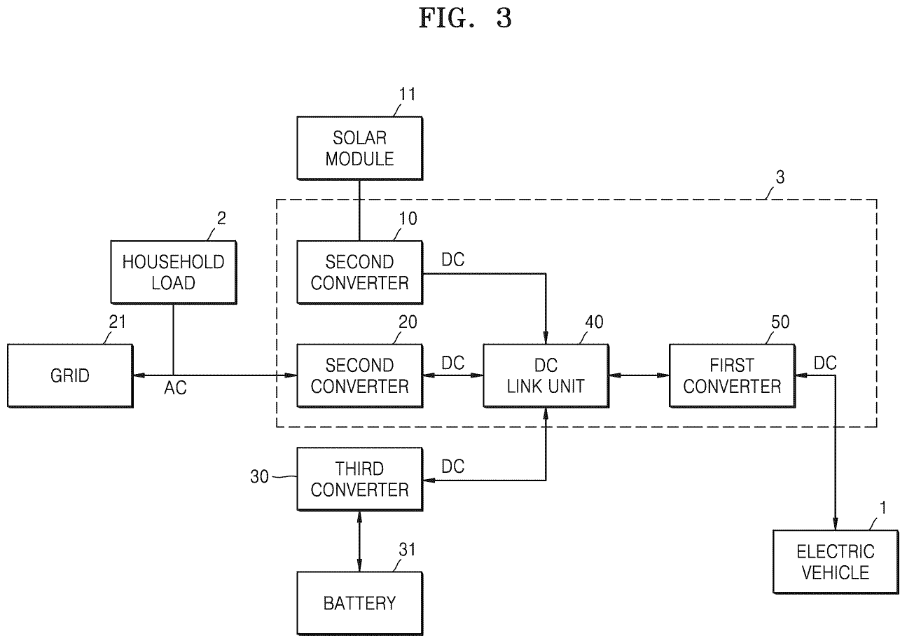

FIG. 3 is a block diagram of an electric vehicle charging device using the household solar inverter according to another embodiment of the present disclosure.

In an example embodiment shown in FIG. 3, when the first inverter 3 is installed to the household solar power generating equipment in such a way that the battery 31 and the third converter 30 are not included, the battery 31 and the third converter 30 may be connected to the DC link unit 40 and the electric vehicle may be charged in the same way as the example embodiment in FIG. 1 described above.

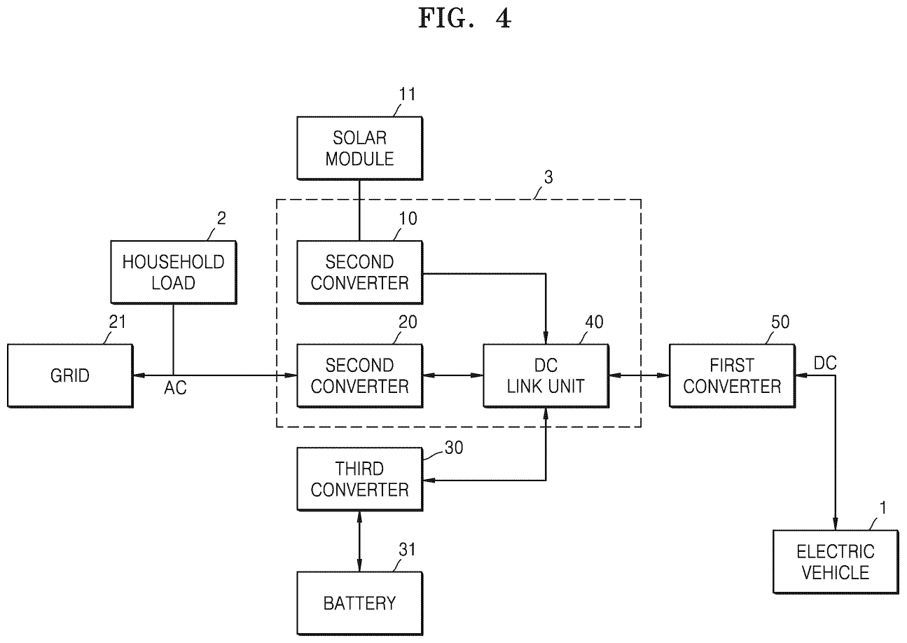

FIG. 4 is a view illustrating a modified example embodiment of FIG. 3.

In an example embodiment in FIG. 4, when the battery 31 and the third converter 30 are installed in a structure separated from the solar module 11, the second converter 10, and the second inverter 20, the first converter 50 may be additionally separated and used for charging electric vehicles as described above in the example embodiment in FIG. 3.

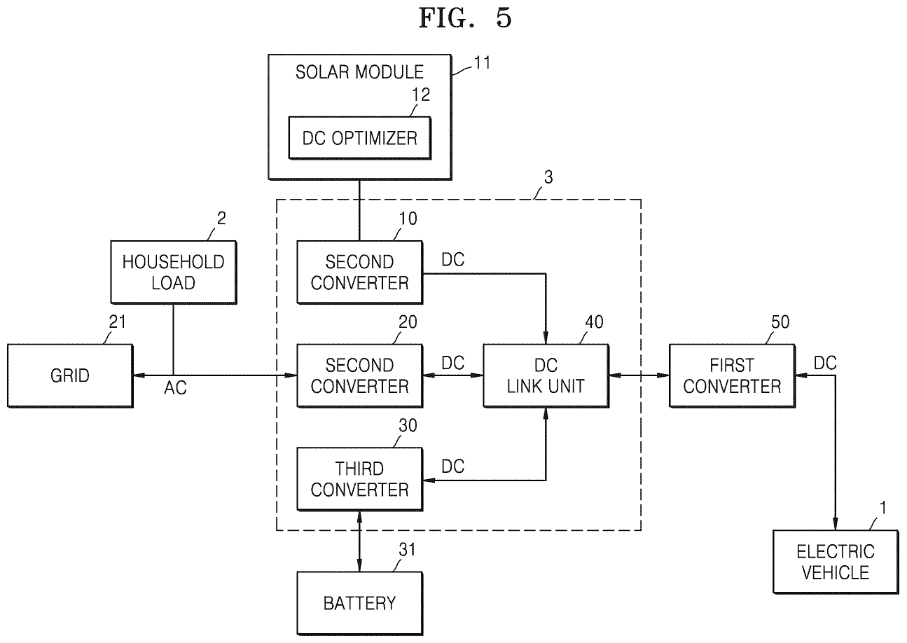

FIG. 5 is a block diagram of another embodiment of an electric vehicle charging device using a household solar inverter according to another embodiment of the present disclosure.

Referring to FIG. 5, a DC optimizer 12 may be further added to the solar module 11 according to the present disclosure. In some embodiments, the DC optimizer 12 may be commonly applied to all embodiments described in the present disclosure.

The DC optimizer 12 may continuously track the maximal power point of the solar module 11, to increase the energy output of the solar module 11 and monitoring performance.

In addition, when power is cut off in the inverter or the grid, the DC optimizer may decrease the DC voltage to a safe level to prevent accidents.

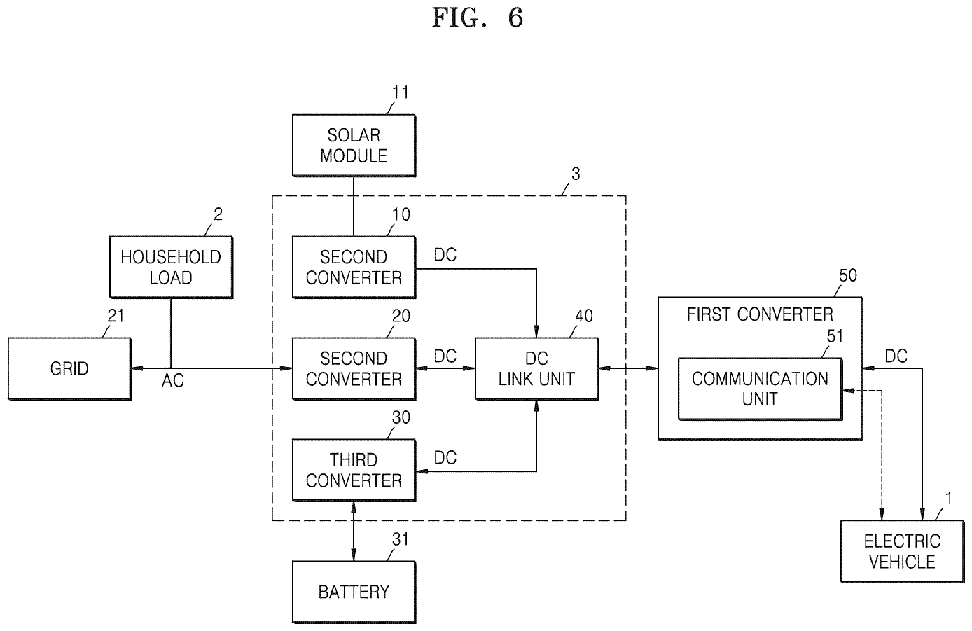

An electric vehicle charging device using a household solar inverter according to another embodiment of the present disclosure in FIG. 6 may further include a communication unit 51 in the first converter 50.

The communication unit 51 added to the first converter 50 may be a modem for performing a power line communication (PLC) with the electric vehicle communication controller (EVCC) of the electric vehicle 1.

In particular, the communication unit 51 may be a supply equipment communication controller (SECC).

By adding the communication unit 51, the present disclosure may easily implement a vehicle to grid (V2G) communication, a vehicle to load (V2L) communication, and a plug and charge (PnC) communication based on the 15118 standards.

The communication unit 52 may be commonly applied to other embodiments described above.

In this way, the present disclosure may simply establish a system for charging electric vehicles at home with reduced costs by adding the bidirectional DC/DC converter to the inverter of the household solar power generating equipment.

Although embodiments according to the present disclosure have been described above, these are merely exemplary, and those skilled in the art will understand that various modifications and equivalent embodiments are possible therefrom. Therefore, the true technical protection scope of the present disclosure should be defined by the following claims.

### EXPLANATION OF REFERENCE NUMERALS DESIGNATING THE MAJOR ELEMENTS OF THE DRAWINGS

10: second converter 11: solar module
12: DC optimizer 20: second inverter
21: grid 30: third converter
31: battery 40: DC link unit
50: first converter 3: first inverter
1: electric vehicle

1. A household electric vehicle charging device comprising:
a first inverter of a household solar power generating equipment; and
a first converter converting power of a direct current (DC) link unit connected to the first inverter to charging power and supplying the charging power to an electric vehicle through a charging cable, to charge the electric vehicle,
wherein power of a second converter based on a solar module, power of a second inverter based on a grid, and power of a third converter based on a battery are supplied to the DC link unit.

2. The household electric vehicle charging device of claim 1, wherein
the first converter further includes a communication unit for communicating with the electric vehicle.

3. The household electric vehicle charging device of claim 1, wherein
the second converter converts DC power of the solar module to DC power of a constant amount and supplies the DC power to the DC link unit, and
the second inverter converts alternating current (AC) power of the grid to DC power and supplies the converted DC power to the DC link unit or converts DC power of the DC link unit to AC power
and supplies the converted AC power to the grid or a load.

4. The household electric vehicle charging device of claim 3, wherein
the third converter supplies power of the battery to the DC link unit or supplies power of the DC link unit to the battery.

5. The household electric vehicle charging device of claim 1, further comprising:
a DC optimizer installed to the solar module.

6. The household electric vehicle charging device of claim 4, wherein
the second converter and the second inverter are included in the first inverter, and
the third converter is provided separately from the first inverter.

7. The household electric vehicle charging device of claim 4, wherein
the first inverter includes the second converter, the second inverter, and the third converter.

8. The household electric vehicle charging device of claim 4, wherein
the first converter is separable from the first inverter.

9. A household electric vehicle charging device, comprising:
a first inverter; and
a first converter converting power of a direct current (DC) link unit to third charging power between first charging power and
second charging power and supplying the third charging power to an electric vehicle,
wherein the first inverter includes
a second converter converting DC power of a solar module and providing the converted DC power to the DC link unit; and
a second inverter converting alternating current (AC) power of a grid and providing the converted AC power to the DC link unit.

10. The household electric vehicle charging device of claim 9, further comprising:
a third converter providing power of the battery to the DC link unit,
wherein the third converter is included in the first inverter or is provided separately from the first inverter and connected to the first inverter.

11. The household electric vehicle charging device of claim 10, wherein
the second inverter is a bidirectional inverter and provides power of the DC link unit to the grid and a load, and
the third converter is a bidirectional converter and charges the battery with power of the DC link unit.

12. The household electric vehicle charging device of claim 10, wherein
the first converter is a bidirectional converter and provides power of the electric vehicle to the DC link unit.

13. The household electric vehicle charging device of claim 10, wherein
the first charging power is greater than or equal to 3 KW and less than or equal to 7 KW,
the second charging power is 50 KW, and
the first converter converts the power of the DC link unit to the third charging power of greater than or equal to 20 KW and less than or equal to 40 KW, to charge the electric vehicle.

14. The household electric vehicle charging device of claim 10, wherein
the first converter further includes a communication unit that performs an inter-process communication (PLC) with an electric vehicle communication controller (EVCC) of the electric vehicle.

15. The household electric vehicle charging device of claim 14, wherein
a V2G (vehicle to grid) communication, a V2L (vehicle to load) communication, and a PnC (plug and charge) communication are possible by the communication unit.

16. The household electric vehicle charging device of claim 9, further comprising:
a DC optimizer added to the solar module.

17. The household electric vehicle charging device of claim 9, wherein
the second converter and the second inverter are provided as the first inverter, and
the first converter is separable from the first inverter.

18. A method of charging an electric vehicle by converting power of a direct current (DC) link unit of a household solar inverter to DC power, the method comprising:
linking, by the DC link unit, power of a solar module, power of a grid, and power of a battery;
converting charging power of the electric vehicle to a third charging power between a first charging power and a second charging power.

19. The method of claim 18, wherein
the first charging power is greater than or equal to 3 KW and less than or equal to 7 KW,
the second charging power is 50 KW, and
the third charging power for charging the electric vehicle is greater than or equal to 20 KW and less than or equal to 40 kW.
